(19) United States
(12) Patent Application Publication
(10) Pub. No.: US 2013/0019125 A1
(43) Pub. Date: Jan. 17, 2013

(54) DETECTION AND CLASSIFICATION OF PROCESS FLAWS USING FUZZY LOGIC

(71) Applicant: Yousef Husain ALMUBARAK, Alhassa (SA)

(72) Inventor: Yousef Husain ALMUBARAK, Alhassa (SA)

(21) Appl. No.: 13/548,310

(22) Filed: Jul. 13, 2012

Related U.S. Application Data
(60) Provisional application No. 61/507,822, filed on Jul. 14, 2011.

(51) Int. Cl. G06F 11/28

(52) U.S. Cl. 714/26; 714/E11.178

(57) ABSTRACT

A fuzzy logic controller for a distributed control system that monitors a large electrical machine in order to detect and identify faults. Variables to be monitored by the fuzzy logic controller include oil pressure, oil temperature, and other critical variables that are used under classical logic to trip the electrical machine offline. After the input and output membership functions are identified, and a rule set is defined, the fuzzy logic controller fuzzifies the monitored variables to the input membership functions, determines an antecedent truth value, and implicates the antecedent truth value onto the output membership function, establishing a fuzzy output set. Where multiple output fuzzy sets are to be combined, they are amalgamated. The output fuzzy set or amalgamated combined output fuzzy set is then converted to a crisp value.

This application is based on and claims priority from U.S. Provisional Patent Application No. 61/507,822, filed on Jul. 14, 2011, the disclosure of which is incorporated herein in their entirety by reference.

### BACKGROUND OF THE INVENTION

1. Field of the Invention

The present invention relates generally to the application of fuzzy logic to distributed control systems to detect and classify faults in electrical machinery, such as air compressors.

2. Description of the Related Art

One definition of fuzzy logic states that fuzzy logic is a form of multi-valued logic derived from fuzzy set theory to deal with reasoning that is approximate rather than precise. Whereas classic propositional logic has two truth values of true (1) or false (0), fuzzy logic variables have a truth value that ranges between 0 and 1, rather than being constrained to the two truth values of classic propositional logic.

In application, fuzzy logic does not provide the user with a binary output or decision, i.e., “yes” or “no.” Rather, it provides a level of certainty or uncertainty. While this may seem counterintuitive, the use of fuzzy logic provides a much better basis for making decisions involving highly complex, automated systems, than does a classic binary system.

Fuzzy logic is built upon the work of Lofti Zadeh, who noted that as the complexity of a system increases, it becomes more difficult, and eventually impossible, to make a precise statement about its behavior. Essentially, one arrives at a point of complexity where fuzzy logic is the only way to resolve a given problem.

On a very simplistic level, fuzzy logic can be seen to operate when, e.g., a driver finds himself in a traffic zone with a speed limit of 45 mph. In determining how fast to drive, the driver takes in multiple points of data, including the actions of drivers behind and in front of him, if there are points at which more traffic enters the traffic flow, and so forth. Not everyone will be driving at the same speed, and an individual's choice of how fast to proceed is based on decision making that happens when all data are processed. There isn't a simple “if-then” relationship with any one factor.

Fuzzy logic has been applied in many different system control and analysis designs, where the complex interplay of variable does not permit simple “yes/no” type solutions.

One problem that is to be addressed is how to apply fuzzy logic to complex systems to warn the operator of potential, automatic shutdowns due to faults within the system. Solving this problem will enable the operator to determine that a fault is imminent, shutdowns and delays can be avoided.

### SUMMARY OF THE INVENTION

The present invention comprehends a system, method and computer program product that executes fuzzy logic on a distributed control system (“DCS”) monitoring a number of operational parameters of an electrical machine in order to provide advance warning of the development of a fault that would cause an automatic shutdown of the electrical machine. The electrical machine can, for example, be an electrical motor such as that in an air compressor, or can be a generator.

This and other advantages of the present invention will become apparent upon consideration of the attached drawings and the following detailed description of the preferred embodiments which are provided by way of illustration and example, but are not to be construed in any way as limiting the invention.

### BRIEF DESCRIPTION OF THE DRAWINGS

The present invention will be described in further detail below and with reference to the accompanying drawings, in which:

FIG. 1 illustrates a prior art method of designing a fuzzy control system;

FIG. 2 provides an example of a saturated steam supply system;

FIG. 3 illustrates a comparison of classical logic's true/false states vs. fuzzy logic's membership functions with triangular shapes;

FIG. 4 illustrates a comparison of classical logic's true/false states vs. fuzzy logic's membership functions with trapezoidal shapes;

FIG. 5 provides an example of fuzzification, derivation of an antecedent truth value, implication and aggregation of a combined output fuzzy set;

FIG. 6 shows the steps of a method for detecting a fault in an electrical machine, using fuzzy logic;

FIG. 7 shows the steps of a method for classifying a fault in an electrical machine, using fuzzy logic;

FIG. 8 is a block diagram of a distributed control system;

FIG. 9 shows modules for detecting a fault in an electrical machine, using fuzzy logic; and

FIG. 10 shows modules for classifying a fault in an electrical machine, using fuzzy logic.

### DETAILED DESCRIPTION OF THE INVENTION

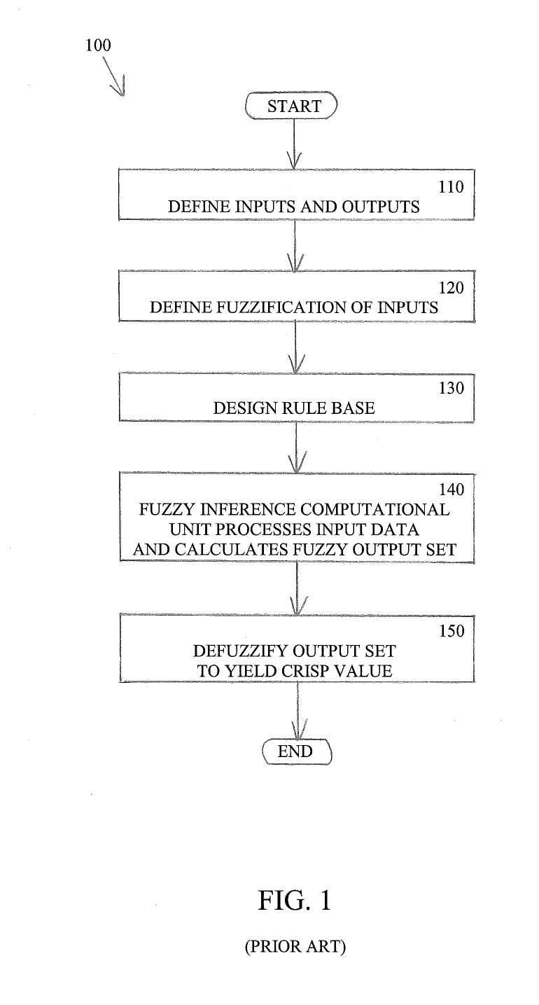

FIG. 1 illustrates a method 100 of designing a fuzzy logic controller. In step 110, the user defines the inputs and outputs of the controller, which include the process observations and controller action to be considered. In step 120, the user defines the fuzzification by which the inputs are to be converted to truth values. In step 130, the user designs the rule base, which links the outputs to the inputs, determining which actions are to be applied to which conditions. In step 140, the fuzzy inference computational unit derives an antecedent truth value from the one or more fuzzified truth values, applies a selected rule weight and implication method to derive an output fuzzy set for each rule, and aggregates all output fuzzy sets into a combined output fuzzy set. Lastly, step 150 defuzzifies the output fuzzy set, yielding a crisp value.

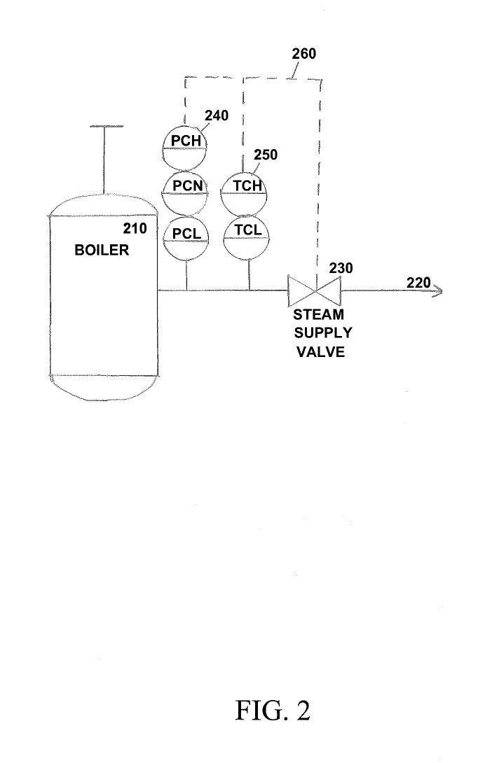

A more detailed description of the system and method is provided in FIGS. 2 through 5, and the associated text, by means of an example. Control of a steam supply valve will be discussed as it is implemented under classical logic and under fuzzy logic. FIG. 2 shows a boiler 210 that produces saturated steam, which is supplied through line 220 to a process. It is critical to the process that the saturated steam be within the temperature range of 292° F. and 320° F., and ideally at 307° F. These temperatures for saturated steam correspond to an ideal pressure of 60 PSIG, a low cut-off pressure of 45 PSIG, and a high cut-off pressure of 75 PSIG. The steam supply valve 230 is therefore controlled by pressure control switches 240, including a high pressure control switch (PCH), a low pressure control switch (PCL), and a normal pressure control switch (PCN). For redundancy, the temperature is also monitored with temperature control switches 250, including a high temperature control switch (TCH) and a low temperature control switch (TCL). The pressure control switches 240 and temperature control switches 250 provide electrical control signals 260 to steam supply valve 230.

The valve should be at an intermediate position when the pressure is 60 PSIG. Relay logic, or the digital equivalent thereof, will start to close the steam supply valve above 320° F. or 75 PSIG, and will start to open the valve below 292° F. or 45 PSIG. The inputs under a classical logic design would be PCH, PCL, PCN, TCH, and TCL. The outputs would be the valve close command and the valve open command.

The individual pressure and temperature switches would be seen as open or closed, for example, assigning a value of “1” if a pressure switch were closed, indicating its setpoint had been reached, or assigning a value of “0” if a pressure switch were open, indicating its setpoint had not been reached. As the decisions would only be made on the basis of whether high pressure or high temperature, low pressure or low temperature, or normal pressure were indicated, there would be no need for a pressure transmitter to measure the precise pressure, and it would suffice to have lower cost pressure switches.

In contrast, in a fuzzy logic implementation, a pressure transmitter would be implemented in lieu of pressure switches, allowing the controller to see a range of pressures. This does not necessarily imply that an implementation of a fuzzy logic controller would require a physical replacement of field switches with transmitters. In many cases, DCS systems already receive inputs from analog transmitters that provide the DCS with a precise value for pressure, flow, temperature, etc., but the DCS is programmed to treat selected setpoint values from those transmitters as inputs to its logic decisions, as though the setpoints were coming from individual switches. Thus, the data from a transmitter is typically already available to a DCS, but is not being used to its full advantage in a classical logic implementation.

In fuzzy logic implementations, instead of “low pressure,” “high pressure,” and “normal pressure” being considered separate inputs, the nomenclature considers “pressure” as a single input variable, with three membership functions, “low,” “normal,” and “high.” In the present simplified example, temperature is the second input variable, and will have two membership functions: “high” and “low.” There would be a single output variable, valve command, with membership functions “close” and “open.” Thus, the combination of input variables and their membership functions, and the combination of the output variable and its membership functions, are comparable to the identifications of inputs and output of classical logic.

Skipping step 120 for the moment, consider step 130, the design of a rule base. This is also similar to that of classical logic, with the rules being expressed verbally as:

Rule #1: IF pressure is high or temperature is high, THEN pressure control valve should start to close;

Rule #2: IF pressure is low or temperature is low, THEN pressure control valve should start to open; and

Rule #3: IF pressure is normal, THEN pressure control valve should stay at its present position.

Note that there is an explicit rule for normal operation, which in classical logic is equivalent to “do nothing.”

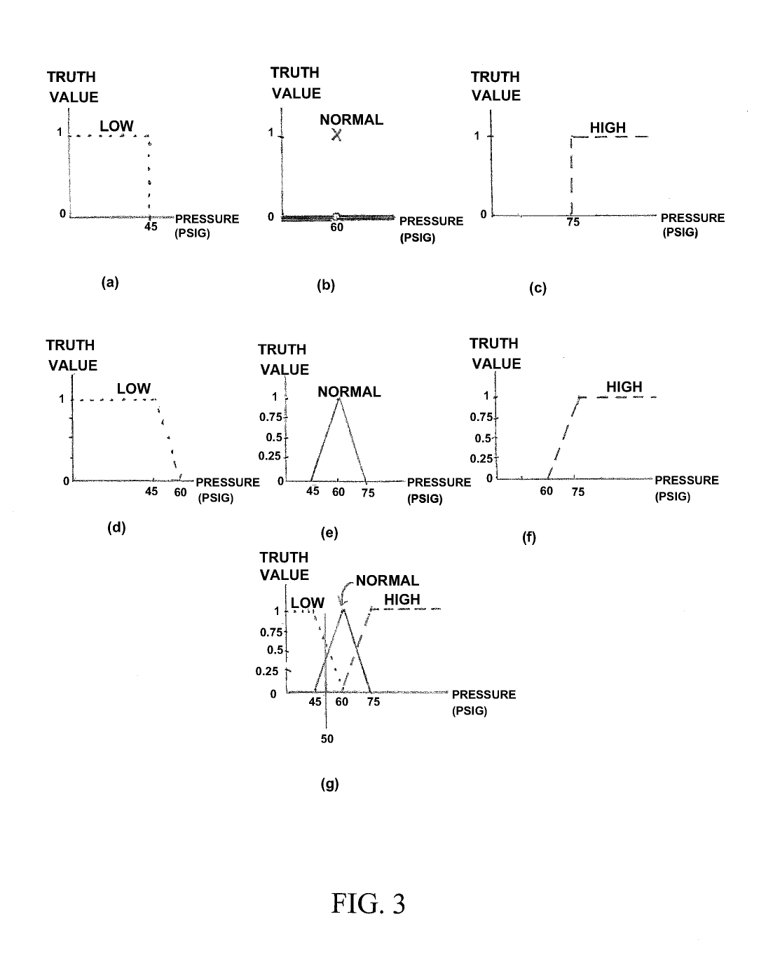

Step 120 is a departure from classical logic. The precise measurement received from a transmitter would be fuzzified into one or more truth values, each of which could be 0, 1, or an intermediate value. FIG. 3 provides an example of fuzzification, where 45 PSIG is identified as a low pressure, 60 PSIG is identified as a normal pressure, and 75 PSIG is identified as a high pressure. FIGS. 3(a), (b), and (c) show an implementation of classical logic, in contrast to FIGS. 3(d), (e), (f), and (g) which show an implementation of fuzzy logic using a straight line shape for fuzzification. Thus, FIG. 3(a) is a chart showing a “low pressure” function according to classical logic, which is true (1), for a pressure below 45 PSIG, and false (0) for a pressure above 45 PSIG. FIG. 3(b) is a chart showing a “normal pressure” function according to classical logic, which is true only at a certain point, 60 PSIG, and false otherwise. FIG. 3(c) is a chart showing a “high pressure” function according to classical logic, which is true only above 75 PSIG, and false below that value. FIG. 3(d) is a fuzzy logic implementation in which the “low pressure” function is true (1) for pressures below 45 PSIG, but it does not become completely false above that value, but rather has a truth value μ that linearly drops from 1 to 0 as the pressure drops from the 45 PSIG (low) level to the 60 PSIG (normal) level. Similarly, FIG. 3(e) is a fuzzy logic implementation in which the normal pressure function is completely true for a pressure of 60 PSIG, but does not become completely false (0) unless the pressure is below the low pressure boundary or above the high pressure boundary. Rather, the truth value for the normal function drops linearly from 1 to 0 as the pressure drops from the normal level to the low pressure boundary, and also drops linearly from 1 to 0 as the pressure rises from the normal level to the high pressure boundary. In such a case, the two symmetrical linear progressions produce a triangular shape.

Finally, FIG. 3(g) shows an overlay of FIGS. 3(d), (e), and (f). For clarity, an overlay of multiple functions is typically color-coded, and in this case the linetypes are varied, so that the low pressure function is a dotted line, the normal pressure function is a solid line, and the high pressure function is a dashed line. An intermediate pressure, such as 50 PSIG, being between the low pressure boundary of 45 PSIG and the normal boundary of 60 PSIG, would under classical logic not be considered either low or normal. However, under fuzzy logic, 50 PSIG, would return a low function truth value of 0.67 (being ⅓ of the way from the truth value of 1 at the low pressure boundary 45 PSIG to the truth value of 0 at the normal pressure boundary of 60 PSIG), and would have a normal function truth value of 0.33 (being ⅔ of the way from the truth value of 1 at the normal pressure boundary to the truth value of 0 at the low pressure boundary of 45 PSIG). In other words, whereas under classical logic a pressure of 50 PSIG would not have been recognized as either a low pressure or a normal pressure, under fuzzy logic it is considered as both—that is, not completely true for either, but partially true.

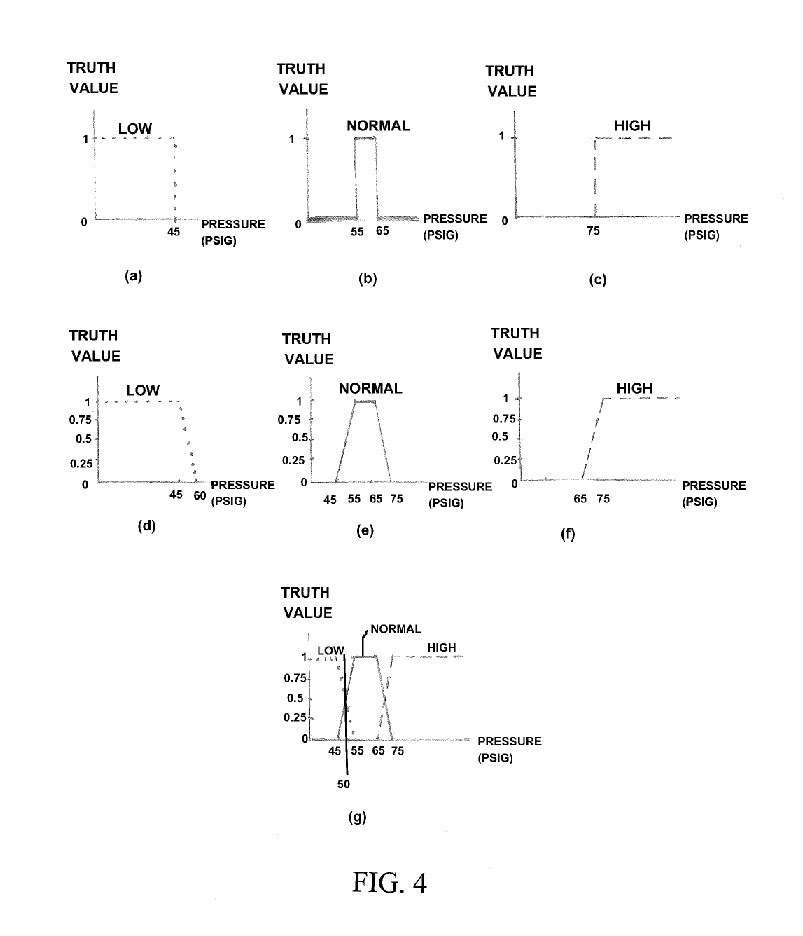

FIG. 4 provides a different example of fuzzification, where the low and high pressures are again identified as 45 PSIG and 75 PSIG, respectively, but this time normal pressure is viewed not as a single point, but rather as a range from 55-65 PSIG. FIG. 4(a), (b), and (c) show an implementation of classical logic, in contrast to FIG. 4(d), (e), (f), and (g) which show an implementation of fuzzy logic using a triangular shape for fuzzification. FIG. 4(a) is identical to FIG. 3(a), and FIG. 4(c) is identical to FIG. 3(c). FIG. 4(b) shows that “normal pressure” is true (having a truth value of 1) for a pressure in the range of 55-65 PSIG, and false otherwise. When the truth values are fuzzified in FIG. 4(d), the truth value drops linearly from 1 at the low pressure boundary of 45 PSIG to 0 at the lower boundary of the normal range, at 55 PSIG. Similarly, in FIG. 4(f), the truth value drops linearly from 1 at the high pressure boundary at 75 PSIG to 0 at the upper boundary of the normal range, at 65 PSIG.

FIG. 4(e) is a fuzzy logic implementation in which the normal pressure function is completely true for a pressure of 55-65 PSIG, but does not become completely false unless the pressure is below the low pressure boundary or above the high pressure boundary. Rather, the truth value for the normal function drops linearly from 1 to 0 as the pressure drops from the lower boundary of the normal level to the low pressure boundary, and also drops linearly from 1 to 0 as the pressure rises from the upper boundary of the normal level to the high pressure boundary. The shape of this fuzzification method is termed “trapezoidal.” FIG. 4(g) shows an overlay of FIGS. 4(d), (e), and (f). In this fuzzification, a pressure of 50 PSIG would occur where the low pressure guide and the normal pressure truth value were both 0.5, indicating the pressure of 50 PSIG to be a partial membership of both the low pressure function and high pressure function.

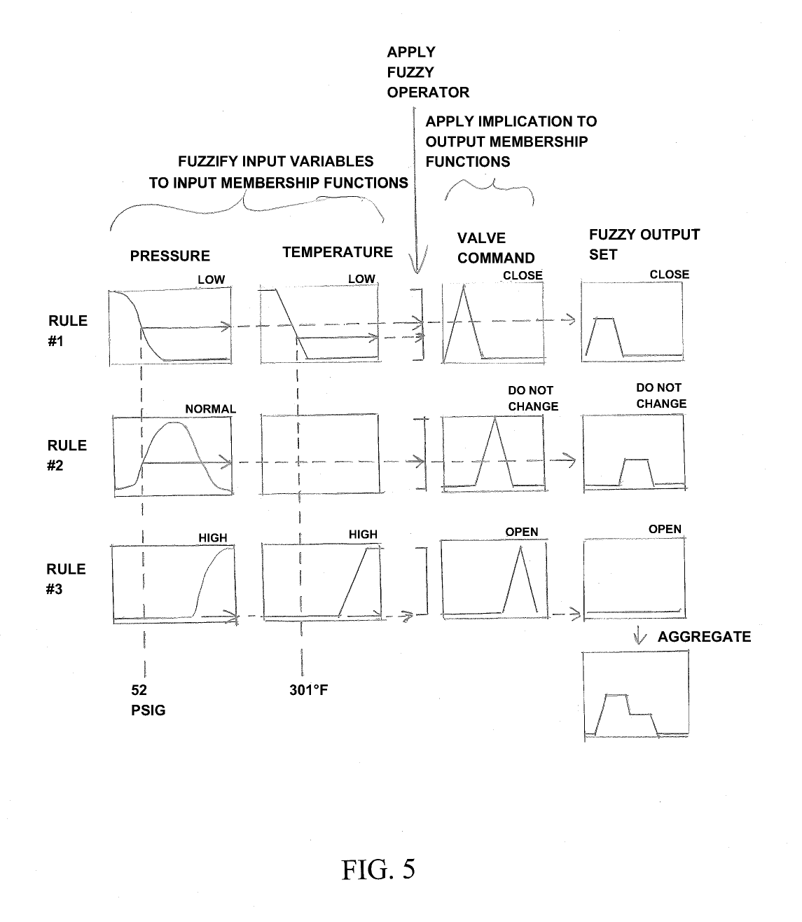

In addition to the linear shape, triangular shape, and trapezoidal shape, another popular shape used for fuzzification is the Gaussian shape, which will be shown in FIG. 5.

Referring once again to FIG. 1, the next task is step 140, determining the intersection and/or union of different combinations of input functions, as required by the rule set, applying an implication method to derive a truth value for each output membership function, and aggregating the output membership functions into an output fuzzy set.

FIG. 5 provides an example of step 140. The top line represents rule #1, “If pressure is low or temperature is low, then close the steam supply valve.” The second line represents rule #2, “If pressure is normal, then leave the steam supply valve at its intermediate position.” The third line represents rule #3, “If pressure is high or temperature is high, then open the steam supply valve.”

The graph at the left for all three rules is the pressure variable, which has a separate membership function for each rule. The actual pressure measured is fuzzified to the membership functions by the Gaussian function, with the “low pressure” membership function used in rule #1, the “normal pressure” membership function in rule #2, and the “high pressure” membership function in rule #3.

The graph adjacent to pressure for rules #1 and #3 is that of the temperature variable, with rule #1 having the “high temperature” membership function, and rule #3 having the “low temperature” membership function. The temperature variable is fuzzified to its membership functions with a trapezoidal shape. There is no temperature membership function for rule #2, as that rule is only dependent on pressure.

Assume that at a given moment in time, indicated by the vertical dashed lines, the pressure reading is 52 PSIG. For rule #1, the 52 PSIG value intersects the “high pressure” membership function at μ=0.5, with the Greek letter mu representing the “truth value.” For rule #2, the pressure reading also intersects the “normal pressure” membership function at μ=0.5. For rule #3, the pressure reading intersects the “high pressure” membership function at μ=0. That is, a pressure of 52 PSIG is not a member of the “high pressure” membership function, as defined. It is, however a partial member of both the “normal pressure” membership function and the “high pressure” membership function.

For a pressure of 52 PSIG, saturated steam should be at 299° F. However, because of an inaccuracy in either the pressure or temperature gauge, imagine that this example produces a reported temperature of 301° F. This value corresponds to μ=0.3 on the “low temperature” membership function, but μ=0 on the “high temperature” membership function.

The inputs have now been fuzzified. That is, for rule #1, “IF pressure is high or temperature is high, THEN pressure control valve should start to close,” fuzzified results have been obtained of μ=0.5 for the “pressure is high” membership function and μ=0.3 for the “temperature is high membership function.” The next step is to apply the fuzzy operator, which for this rule is “OR.” Any number of well-defined methods can be applied for AND and OR operations. The commercial product MATLAB offers, for the AND operator, a choice of min (minimum) or prod (product), a scaling function. For the OR operator, MATLAB offers a choice of max (maximum) or probor (a probabilistic method, also known as an algebraic sum). Probor is defined as:

Probor(a,b)=a+b−ab

Selecting the max technique for the OR operator yields μ=0.5 for rule #1.

For rule #2, there is only one input membership function, “normal pressure,” which was previously identified to have μ=0.5.

For rule #3, it has been shown previously that the measured pressure of 52 PSIG was not part of the membership function for “high pressure,” and that the measured temperature of 301° F. was not part of the input membership functions for “high temperature.” In other words, μ=0 for both, and thus applying the OR function, with the selected method of max, also yields μ=0.

The next step is to determine the weight of each rule. This is generally 1, as it is in this example.

The next step is to apply the implication method. MATLAB offers a choice of Mamdani-type inference or Sugeno-type inference. The Mamdani method expects the output membership functions to be fuzzy sets, and after the aggregation process, there is a fuzzy set for each output variable. This fuzzy set then requires defuzzification. In contrast, Sugeno inference will use a single spike as the output function rather than a distributed fuzzy set. The example uses the Mamdani method. This begins with a fuzzification of the output membership functions for the single output variable, “valve command.” The output membership function for rule #1 is “command valve to close,” while the output membership function for rule #2 is “do not change valve,” and the output membership function for rule #3 is “command valve to open.” These membership functions are selected to have triangular shapes. The implication method then applies the membership value obtained from the input membership functions, as selected by the fuzzy operator. MATLAB supports two implication methods, being the same functions that are used by the AND method: min (minimum), which truncates the output membership function to derive to the fuzzy output set, and prod (product), which scales the output membership function. Selecting min and reviewing rule #1, the value μ=0.5 that was selected by the fuzzy operator is applied to the triangular shape of the “command valve to close” membership function, truncating it. The truncated version for each of rules #1, #2, and #3 appear in the right-most column, representing the fuzzy output sets for those output membership functions.

Having obtained the fuzzy output sets for each of the membership functions of the output variable, all that is required to complete step 140 of method 100 of FIG. 1 is to aggregate these into a single fuzzy output set. Again, a number of methods are available, and MATLAB supports max, probor, and sum (the sum of each rule's output set). Applying the max method yields the aggregated fuzzy output set, as shown in the lower right-hand corner of FIG. 5.

The final step of method 100, step 150, is the defuzzification of the output function fuzzy set into a crisp value. There are a number of different methods of defuzzification, including the maximum membership method, the center of gravity defuzzification, the middle of maxima and the mean of maxima method. The most commonly used method is the center of gravity method. The method described is for a particular point in time. Thus, a crisp value is received for that moment, and the crisp results will be tracked and stored over a period of time. If the curve of these crisp values then shows a value out of the normal range, an operator should consider it as a predictor that the system under review is approaching one of the setpoints that would be established under conventional logic, i.e., fuzzy logic can, in theory, provide advance notice of an actionable event before it occurs.

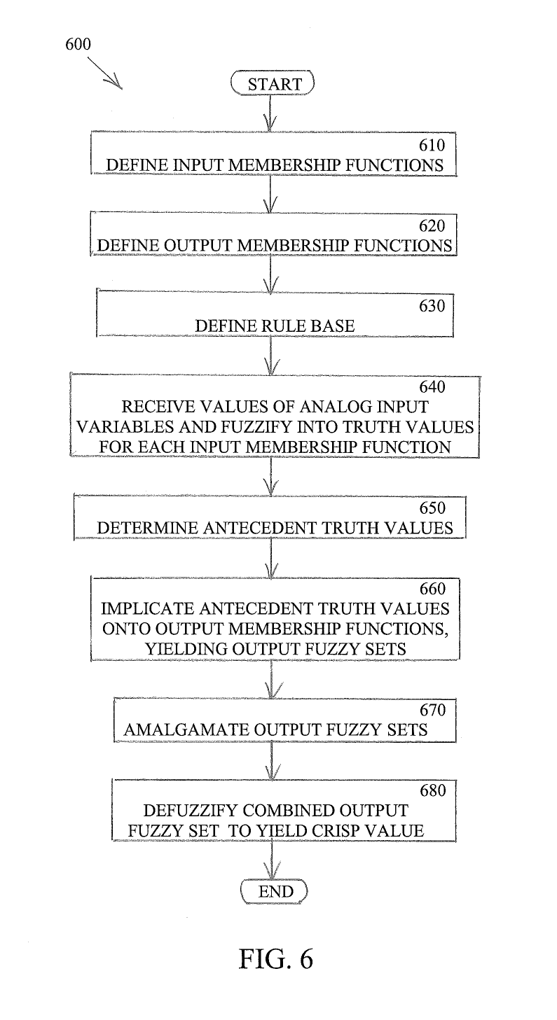

FIG. 6 shows one embodiment of the invention, being a method 600 of detecting a fault in large electrical machines using fuzzy logic programmed into a distributed control system.

As a minimum, large electrical machines are protected by having their lubrication oil temperature and pressure monitored by the DCS. In one experiment applying an embodiment of the invention, modeling was conducted on a desktop computer running MATLAB, using data measured and recorded by a DCS for a large air compressor that had more than 60 variables measured. An engineering review showed that under the current classical logic being employed, 15 temperature, pressure and vibration variables could lead to a shutdown of the air compressor. Following is a list of the 15 variables, with the types of settings identified on a piping and instrumentation diagram (P&ID):

Lube oil pressure 84PIX23 - Normal, low, and low-low
Lube oil temperature 84TIX11 - Low, normal, high, and high-high
3rd stage inlet temperature 84TIX02 - Normal, high, and high-high
2nd stage inlet temperature 84TIX22 - Normal, high, and high-high
Temperature of high-speed pinion 84TIX19 - Normal, high, and high-high
Temperature of low-speed pinion 84TIX21 - Normal, high, and high-high
Bull gear oil temperature 84TIX20 - Normal, high, and high-high
Main motor DE BG temperature 84TIX18 - Normal, high, and high-high
Main motor NDE BG temperature 84TIX17 - Normal, high, and high-high
Lube oil pressure 84PIX29 - Normal, and low-low
Motor NDE vibrations 84VIX06 - Normal, high, and high-high
Motor DE vibration 84VIX07 - Normal, high, and high-high
Vibration of high-speed pinion vibration 84VIX08 - Normal, high, and
high-high
Vibration low-speed pinion 84VIX09 - Normal, high, high-high
Axial shaft vibration 84VIX12- Normal, high, high-high, low, and
low-low

As noted, fuzzy logic has been incorporated in machine control, but has not been widely employed for detection and classification of faults. In step 610, a user defines at least one input membership function for each of at least two analog variables from sensors associated with the electrical machine. For example, lube oil pressure 84PIX23 was given an input membership functions of “normal,” “low, and “low-low.” The user defines the shape of each membership function and at least one membership boundary. In a preferred embodiment, the shapes selected were either triangular or trapezoidal.

In a preferred embodiment, the fuzzification of the values of the input variables was accomplished by applying a linear shape to the truth values between 0 and 1. For example, the P&ID showed that lube oil pressure 84PIX23 should be considered normal at 26 PSIG, low at 21 PSIG, and low-low at 15 PSIG. This was represented in MATLAB as:

[Input1]
Name=’Lube_oil_pressure_84-PI-X23’
Range=[0 100]
NumMFs=3
MF1=’LowLow’:’trapmf’,[−36 −4 15 21]
MF2=’Low’:’trimf’,[15 21 26]
MF3=’Normal’:’trapmf’,[21 26 104 136]

That is, the first input variable is called “Lube oil pressure 84-PI-X23,” and it has a range from 0 to 100. This variable has three membership functions. The first membership function is “low-low,” and it is assigned a trapezoidal shape, being 0 at −36 PSIG, climbing to 1 at −4 PSIG, remaining at 1 until 15 PSIG, and then trailing to zero at 21 PSIG. There is no negative pressure in this context; rather, this is the way one programs MATLAB to represent a partial trapezoidal shape. It is the same as saying that from zero to 15 PSIG, the membership function is at 1, then it begins to trails off linearly, reaching 0 at 21 PSIG. The second membership function is “low,” and it is at 0 below 15 PSIG, then climbs linearly to 1 at 21 PSIG, then trails off linearly, reaching 0 at 26 PSIG. The third membership function is “normal,” with a trapezoidal shape that is 0 below 21 PSIG, then climbs to 1 at 26 PSIG, and remains at 1 until 104 PSIG, at which it drops gradually to 0 at 136 PSIG. The very high values of 104 PSIG and 136 PSIG will never be reached in practice; again, this is a convenient way of programming a partial trapezoidal shape in MATLAB.

Thus, a measurement of 18 PSIG would result in a truth value of 0.5 for the variable as a member of the “low-low” membership function, a truth value of 0.5 as a member of the “low” membership function, and a truth value of 0 as a member of the “normal” membership function.

The other 14 input variables and their respective membership functions were programmed into MATLAB similarly, as well as the single output variable “compressor performance” and its three membership functions: “normal,” “high,” and “high-high.”

In step 620, the user defines “normal, “high” and “high-high” output membership functions for a variable representing a performance level for the electrical machine. Note that some of the input variables have “low” and “low-low” values; these are grouped, respectively, with “high” and “high-high.” For each of the three output membership functions, the user defines the shape and at least one membership boundary.

In step 630, the user develops a rule base. In the experiment, the rule base was:

1) The compressor will be normal if and only if all of the input variables are normal.

2) The compressor performance will be high if any of the input variables goes high.

3) The compressor performance will be high-high if any of the input variables is high-high.

4) The compressor performance will be high if axial shaft vibration is low.

5) The compressor performance will be high-high if axial shaft vibration is low-low.

Note that rules 4 and 5 are necessary, at least within the confines of MATLAB, because that program only allows for one membership function per variable per rule. For example, rule 3 cannot include “if axial shaft vibration is high or if axial shaft vibration is low.” Thus, rule 3 includes one of them, and the remaining membership function is placed in a separate rule.

Therefore, the rules are programmed as:

| | |
|---|---|
| 1. | IF (Lube_oil_pressure_84-PI-X23 is Normal) |
| | AND (Lube_oil_temperature_84-TI-X11 is Normal) |
| | AND (3rd_stage_inlet_temperature_84-TI-X02 is Normal) |
| | AND (2nd_stage_inlet_temperature_84-TI-X22 is Normal) |
| | AND (Hi_speed_pinion_oil_temperature_84-TI-X19 is Normal) |
| | AND (Low_speed_pinion_oil_temperature_84-TI-X21 is Normal) |
| | AND (Bull_gear_oil_temperature_84-TI-X20 is Normal) |
| | AND (Main_motor_NDE_BG_temperature_84-TI-X18 is Normal) |
| | AND (Main_motor_NDE_BG_temperature_84-TI-X17 is Normal) |
| | AND (Lube_oil_pressure_84-PI-X29 is Normal) |
| | AND (Motor_NDE_vibration_84-VI-X06 is Normal) |
| | AND (Motor_NDE_vibration_84-VI-X07 is Normal) |
| | AND (High_speed_pinion_vibration_84-VI-X08 is Normal) |
| | AND (Low_speed_pinion_vibration_84-VI-X09 is Normal) |
| | AND (Axial_shaft_vibration_84-VI-X12 is Normal) |
| | THEN (Compressor_performance is Normal). |
| 2. | IF (Lube_oil_pressure_84-PI-X23 is Low) |
| | OR (Lube_oil_temperature_84-TI-X11 is High) |
| | OR (3rd_stage_inlet_temperature_84-TI-X02 is High) |
| | OR (2nd_stage_inlet_temperature_84-TI-X22 is High) |
| | OR (Hi_speed_pinion_oil_temperature_84-TI-X19 is High) |
| | OR (Low_speed_pinion_oil_temperature_84-TI-X21 is High) |
| | OR (Bull_gear_oil_temperature_84-TI-X20 is High) |
| | OR (Main_motor_NDE_BG_temperature_84-TI-X18 is High) |
| | OR (Main_motor_NDE_BG_temperature_84-TI-X17 is High) |
| | OR (Lube_oil_pressure_84-PI-X29 is High) |
| | OR (Motor_NDE_vibration_84-VI-X06 is High) |
| | OR (Motor_NDE_vibration_84-VI-X07 is High) |
| | OR (High_speed_pinion_Vibration_84-VI-X08 is High) |
| | OR (Low_speed_pinion_Vibration_84-VI-X09 is High) |
| | OR (Axial_Shaft_Vibration_84-VI-X12 is High) |
| | THEN (Compressor_performance is High) |
| 3. | IF (Lube_oil_pressure_84-PI-X23 is Low-Low) |
| | OR (Lube_oil_temperature_84-TI-X11 is High-High) |
| | OR (3rd_stage_inlet_temperature_84-TI-X02 is High-High) |
| | OR (2nd_stage_inlet_temperature_84-TI-X22 is High-High) |
| | OR (Hi_speed_pinion_oil_temperature_84-TI-X19 is High-High) |
| | OR (Low_speed_pinion_oil_temperature_84-TI-X21 is |
| | High-High) |
| | OR (Bull_Gear_oil_temperature_84-TI-X20 is High-High) |
| | OR (Main_motor_NDE_BG_temperature_84-TI-X18 is |
| | High-High) |
| | OR (Main_motor_NDE_BG_temperature_84-TI-X17 is |
| | High-High) |
| | OR (Lube_oil_pressure_84-PI-X29 is Low-Low) |
| | OR (Motor_NDE_vibration_84-VI-X06 is High-High) |
| | OR (Motor_NDE_vibration_84-VI-X07 is High-High) |
| | OR (High_speed_pinion_vibration_84-VI-X08 is High-High) |
| | OR (Low_speed_pinion_vibration_84-VI-X09 is High-High) |
| | OR (Axial_Shaft_vibration_84-VI-X12 is High-High) |
| | THEN (Compressor_performance is High-High) |
| 4. | IF (Axial Shaft Vibrations 84-VI-X12 is Low) |
| | THEN (Compressor_performance is High) |
| 5. | IF (Axial_Shaft_vibration_84-VI-X12 is Low-Low) |
| | THEN (Compressor_performance is High-High) |

MATLAB was programmed with the rules as follows:

$$\begin{matrix}[ Rules ] & \\ \begin{matrix}3 & 2 & 1 & 1 & 1 & 1 & 1 & 1 & 1 & 2 & 1 & 1 & 1 & 1 & 3 , & 1 & ( 1 ) : & 1 \\ 2 & 3 & 2 & 2 & 2 & 2 & 2 & 2 & 2 & 0 & 2 & 2 & 2 & 2 & 4 , & 2 & ( 1 ) : & 2 \\ 1 & 4 & 3 & 3 & 3 & 3 & 3 & 3 & 3 & 1 & 3 & 3 & 3 & 3 & 5 , & 3 & ( 1 ) : & 2 \\ 0 & 0 & 0 & 0 & 0 & 0 & 0 & 0 & 0 & 0 & 0 & 0 & 0 & 0 & 2 , & 2 & ( 1 ) : & 1 \\ 0 & 0 & 0 & 0 & 0 & 0 & 0 & 0 & 0 & 0 & 0 & 0 & 0 & 0 & 1 , & 3 & ( 1 ) : & 1\end{matrix} & \end{matrix}$$

The top line represents Rule #1, and the first 15 digits preceding the comma represent the 15 input variables, with the value of the digit representing the membership function of that input variable. Thus, for the first input variable, which was identified above as lube oil pressure 84-PI-X23, what is being considered is the third membership function, “normal.” After the comma is a digit representing the sole output variable, “compressor performance,” with the value of the digit representing the particular membership function of that output variable, which in this case is the first membership function, “normal.” The value in parenthesis is the weight of the rule; these have all been given an equal weight. Finally, after the colon is a digit representing the operator to be applied to the values of the input membership functions, with 1 being the “AND” function and 2 being the “OR” function. As noted above, the selection was made that the AND method would be min and the OR method would be max.

In step 640, the values of the analog input variables were received from the sensors, and fuzzified, so that a truth value is calculated for each input membership function associated with that analog input variable.

In step 650, an antecedent truth value is determined for each rule of the rule set by applying the fuzzy operator to the truth values of the input membership functions. In a preferred embodiment, the minimum method was selected for the AND function, as shown above in rule 1 of the experiment, and the maximum method was selected for the OR function, as shown above in rules 2 and 3 of the experiment. If a rule only contained one input membership function, such as in rules 4 and 5 of the experiment, then the truth value for that input membership function will be used as the antecedent truth value.

In step 660, for each rule, the antecedent truth value is implicated onto the output membership function for that rule, yielding an output fuzzy set. In a preferred embodiment, the minimum function was used for the implication.

In step 670, the output fuzzy sets were amalgamated into a combined output fuzzy set. In a preferred embodiment, the maximum function was used for the amalgamation.

In step 680, the combined output fuzzy set was defuzzified into a crisp value, which was then recorded over time. In a preferred embodiment, the center of gravity function was used for the defuzzification.

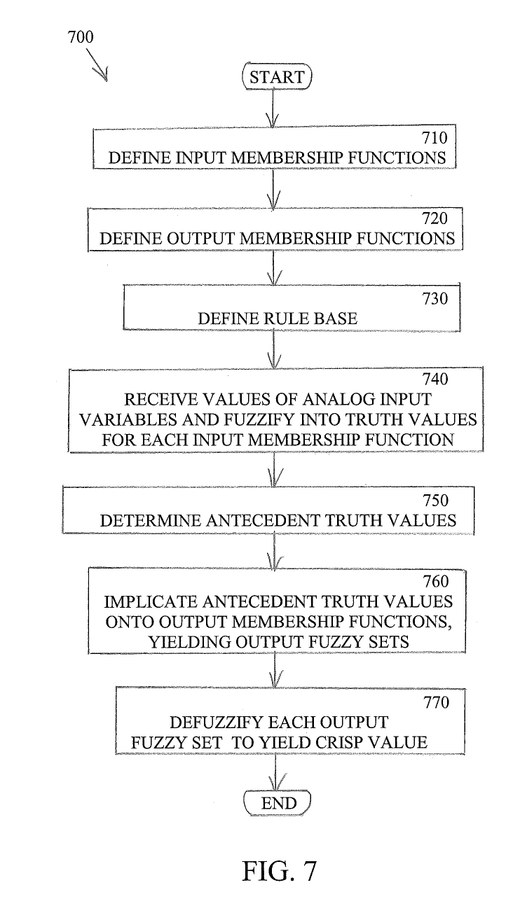

The results of the experiment were favorable, with the last two months of historic data before air compressor faults showing that the fault could have been anticipated in four out of five instances.

Whereas the method 600 of FIG. 6 tracks all input variables simultaneously, yielding a crisp value that indicates the health of the electric machine, a second embodiment shown in FIG. 7 tracks each input variable separately, yielding a crisp value for each that can aid in classifying a developing fault.

Step 710, defining the input membership functions, is analogous to step 610 of FIG. 6. As before, the user defines the shapes and at least one membership boundary.

Step 720, defining the output membership functions, is different. Using the previous compressor discussed in the experiment above, instead of one output (“compressor performance”) with three membership functions (“normal,” “high,” and “high-high”), in this method 700 there are fifteen outputs, one for each input variable, with only one membership function (“trouble”) for each. The user defines the shapes and at least one membership boundary. In a preferred embodiment, the shapes were triangular.

In step 730, the user defines the rule base. The first of the 15 rules is

| | |
|---|---|
| 1. | IF (Lube_oil_pressure_84-PI-X23 is Low-Low) |
| | AND (Lube_oil_temperature_84-TI-X11 is NOT High-High) |
| | AND (3rd_stage_inlet_temperature_84-TI-X02 is NOT High-High) |
| | AND (2nd_stage_inlet_temperature_84-TI-X22 is NOT |
| | High-High) |
| | AND (Hi_speed_pinion_oil_temperature_84-TI-X19 is NOT |
| | High-High) |
| | AND (Low_speed_pinion_oil_temperature_84-TI-X21 is NOT |
| | High-High) |
| | AND (Bull_Gear_oil_temperature_84-TI-X20 is NOT High-High) |
| | AND (Main_motor_NDE_BG_temperature_84-TI-X18 is NOT |
| | High-High) |
| | AND (Main_motor_NDE_BG_temperature_84-TI-X17 is NOT |
| | High-High) |
| | AND (Lube_oil_pressure_84-PI-X29 is NOT Low-Low) |
| | AND (Motor_NDE_vibration_84-VI-X06 is NOT High-High) |
| | AND (Motor_NDE_vibration_84-VI-X07 is NOT High-High) |
| | AND (High_speed_pinion_vibration_84-VI-X08 is NOT |
| | High-High) |
| | AND (Low_speed_pinion_vibration_84-VI-X09 is NOT |
| | High-High) |
| | AND (Axial_Shaft_vibration_84-VI-X12 is NOT High-High) |
| | THEN (Lube_oil_pressure_84-PI-X23 is TROUBLE) |

Note the introduction of the “NOT” operator, which in fuzzy logic produces the complement of the membership function being acted upon. In other words, an analog value which would produce a truth value of x on the original membership function would produce a truth value of 1-x on the complementary membership function created by the NOT operator. In the experiment, the other 14 rules were created similarly, focusing on one analog variable at a time, checking to see if it is High-High while all of the other analog variables were not High-High.

MATLAB was programmed with the rules as follows:

$$\begin{matrix}[ Rules ] & \\ \begin{matrix}1 & - 4 & - 3 & - 3 & - 3 & - 3 & - 3 & - 3 & - 3 & - 1 & - 3 & - 3 & - 3 & - 3 & - 5 , & 1 & 0 & 0 & 0 & 0 & 0 & 0 & 0 & 0 & 0 & 0 & 0 & 0 & 0 & 0 & ( 1 ) : & 1 \\ - 1 & 4 & - 3 & - 3 & - 3 & - 3 & - 3 & - 3 & - 3 & - 1 & - 3 & - 3 & - 3 & - 3 & - 5 , & 0 & 1 & 0 & 0 & 0 & 0 & 0 & 0 & 0 & 0 & 0 & 0 & 0 & 0 & 0 & ( 1 ) : & 1 \\ - 1 & - 4 & 3 & - 3 & - 3 & - 3 & - 3 & - 3 & - 3 & - 1 & - 3 & - 3 & - 3 & - 3 & - 5 , & 0 & 0 & 1 & 0 & 0 & 0 & 0 & 0 & 0 & 0 & 0 & 0 & 0 & 0 & 0 & ( 1 ) : & 1 \\ - 1 & - 4 & - 3 & 3 & - 3 & - 3 & - 3 & - 3 & - 3 & - 1 & - 3 & - 3 & - 3 & - 3 & - 5 , & 0 & 0 & 0 & 1 & 0 & 0 & 0 & 0 & 0 & 0 & 0 & 0 & 0 & 0 & 0 & ( 1 ) : & 1 \\ - 1 & - 4 & - 3 & - 3 & 3 & - 3 & - 3 & - 3 & - 3 & - 1 & - 3 & - 3 & - 3 & - 3 & - 5 , & 0 & 0 & 0 & 0 & 1 & 0 & 0 & 0 & 0 & 0 & 0 & 0 & 0 & 0 & 0 & ( 1 ) : & 1 \\ - 1 & - 4 & - 3 & - 3 & - 3 & 3 & - 3 & - 3 & - 3 & - 1 & - 3 & - 3 & - 3 & - 3 & - 5 , & 0 & 0 & 0 & 0 & 0 & 1 & 0 & 0 & 0 & 0 & 0 & 0 & 0 & 0 & 0 & ( 1 ) : & 1 \\ - 1 & - 4 & - 3 & - 3 & - 3 & - 3 & 3 & - 3 & - 3 & - 1 & - 3 & - 3 & - 3 & - 3 & - 5 , & 0 & 0 & 0 & 0 & 0 & 0 & 1 & 0 & 0 & 0 & 0 & 0 & 0 & 0 & 0 & ( 1 ) : & 1 \\ - 1 & - 4 & - 3 & - 3 & - 3 & - 3 & - 3 & 3 & - 3 & - 1 & - 3 & - 3 & - 3 & - 3 & - 5 , & 0 & 0 & 0 & 0 & 0 & 0 & 0 & 1 & 0 & 0 & 0 & 0 & 0 & 0 & 0 & ( 1 ) : & 1 \\ - 1 & - 4 & - 3 & - 3 & - 3 & - 3 & - 3 & - 3 & 3 & - 1 & - 3 & - 3 & - 3 & - 3 & - 5 , & 0 & 0 & 0 & 0 & 0 & 0 & 0 & 0 & 1 & 0 & 0 & 0 & 0 & 0 & 0 & ( 1 ) : & 1 \\ - 1 & - 4 & - 3 & - 3 & - 3 & - 3 & - 3 & - 3 & - 3 & 1 & - 3 & - 3 & - 3 & - 3 & - 5 , & 0 & 0 & 0 & 0 & 0 & 0 & 0 & 0 & 0 & 1 & 0 & 0 & 0 & 0 & 0 & ( 1 ) : & 1 \\ - 1 & - 4 & - 3 & - 3 & - 3 & - 3 & - 3 & - 3 & - 3 & - 1 & 3 & - 3 & - 3 & - 3 & - 5 , & 0 & 0 & 0 & 0 & 0 & 0 & 0 & 0 & 0 & 0 & 1 & 0 & 0 & 0 & 0 & ( 1 ) : & 1 \\ - 1 & - 4 & - 3 & - 3 & - 3 & - 3 & - 3 & - 3 & - 3 & - 1 & - 3 & 3 & - 3 & - 3 & - 5 , & 0 & 0 & 0 & 0 & 0 & 0 & 0 & 0 & 0 & 0 & 0 & 1 & 0 & 0 & 0 & ( 1 ) : & 1 \\ - 1 & - 4 & - 3 & - 3 & - 3 & - 3 & - 3 & - 3 & - 3 & - 1 & - 3 & - 3 & 3 & - 3 & - 5 , & 0 & 0 & 0 & 0 & 0 & 0 & 0 & 0 & 0 & 0 & 0 & 0 & 1 & 0 & 0 & ( 1 ) : & 1 \\ - 1 & - 4 & - 3 & - 3 & - 3 & - 3 & - 3 & - 3 & - 3 & - 1 & - 3 & - 3 & - 3 & 3 & - 5 , & 0 & 0 & 0 & 0 & 0 & 0 & 0 & 0 & 0 & 0 & 0 & 0 & 0 & 1 & 0 & ( 1 ) : & 1 \\ - 1 & - 4 & - 3 & - 3 & - 3 & - 3 & - 3 & - 3 & - 3 & - 1 & - 3 & - 3 & - 3 & - 3 & 5 , & 0 & 0 & 0 & 0 & 0 & 0 & 0 & 0 & 0 & 0 & 0 & 0 & 0 & 0 & 1 & ( 1 ) : & 1\end{matrix} & \end{matrix}$$

The top line represents Rule #1, and the first 15 digits preceding the comma represent the 15 input variables, with the value of the digit representing the membership function of that input variable. A negative sign indicates a NOT function. Thus, for the first input variable, which was identified above as lube oil pressure 84-PI-X23, what is being considered is the first membership function, “low-low.” After the comma are 15 digits representing the 15 output variables, with the value of the digit representing the particular membership function of that output variable. As noted, only one membership function, “trouble,” was assigned to each output variable. For Rule #1, a “1” in the first column after the comma indicates that the antecedent truth value is to be implicated to the “trouble” membership function for lube oil pressure 84-PI-X23, while a “0” in every other column means there is to be no implication for that rule with regard to any other variable.

In step 740, the values of the analog input variables were received from the sensors and fuzzified, so that a truth value is calculated for each input membership function associated with that analog input variable, or its complement when the NOT operator is present.

In step 750, an antecedent truth value is determined for each rule of the rule set by applying the fuzzy operator AND to the truth values of the input membership functions. In a preferred embodiment, the minimum method was selected for the AND function.

In step 760, for each rule, the antecedent truth value is implicated onto the output membership function for that rule, yielding an output fuzzy set. In a preferred embodiment, the minimum function was used for the implication. As noted above, in this method there are 15 outputs, but each only has a single membership function, “trouble.”

Whereas method 600 included a step for amalgamation of multiple membership functions per output variable, no such step is needed in method 700, as there is only one membership function per output variable.

In step 770, the output set for each of the 15 variables was defuzzified into a crisp value, which was then recorded over time. In a preferred embodiment, the center of gravity function was used for the defuzzification.

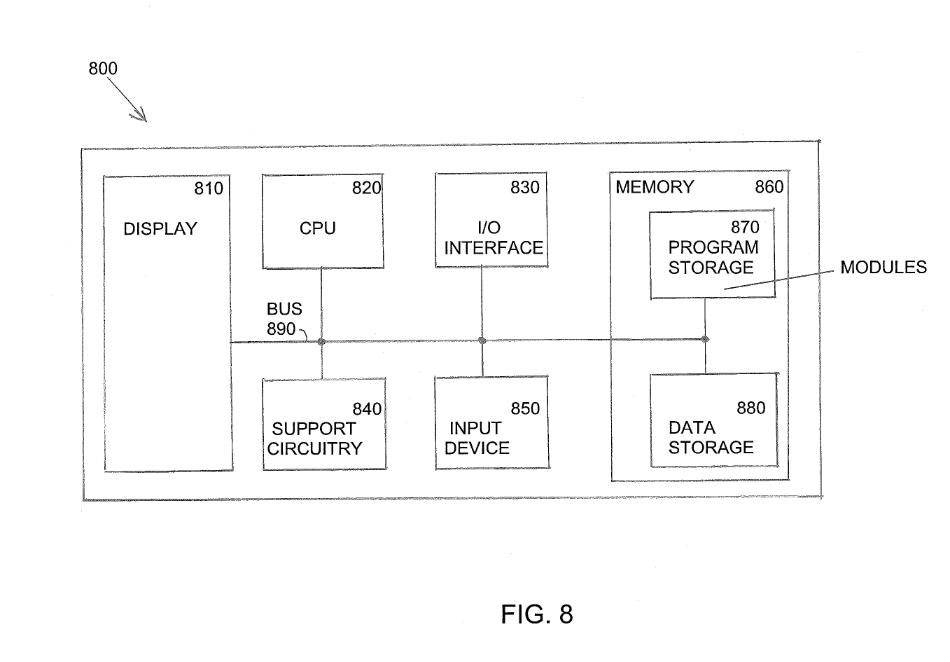

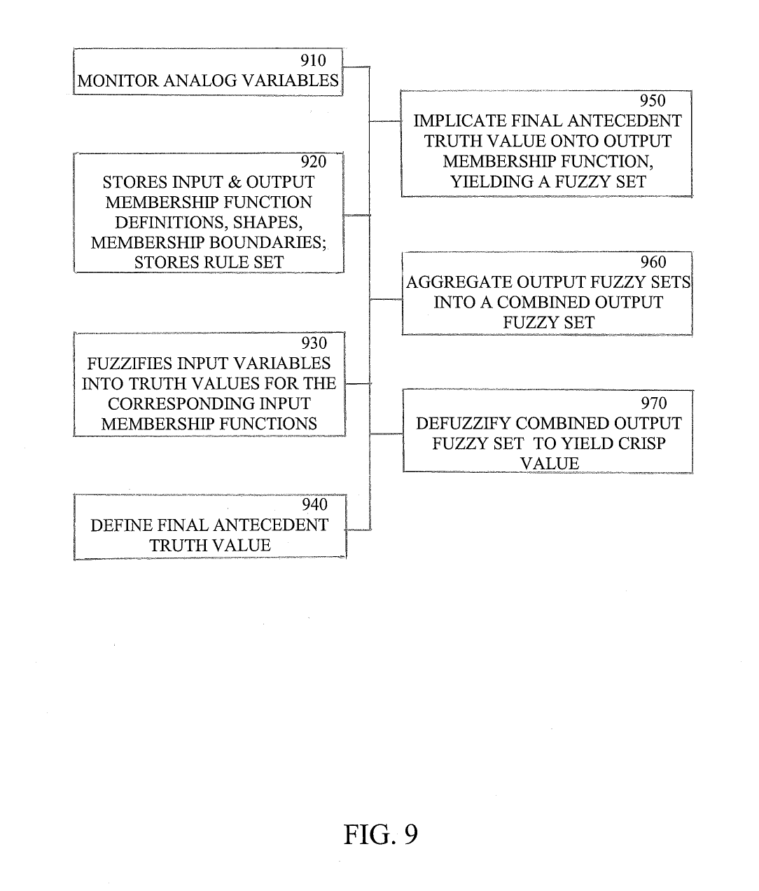

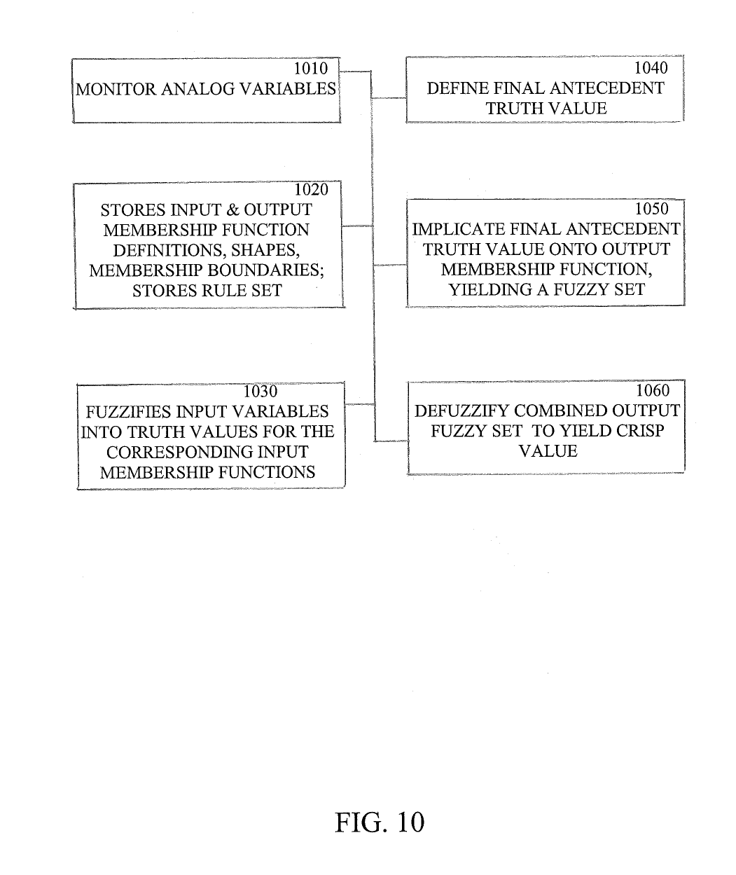

The results of the experiment were favorable, showing that the precise analog input variable that would eventually cause the compressor to trip could have been identified ahead of time. In another embodiment, the invention is implemented as a system including a distributed control system and modules. FIG. 8 is an illustration of a distributed control system, which includes a non-volatile memory 860 that includes program storage 870 and data storage 880; a processor 820; a human-machine interface such as a display 810 and an input device 850; input and output circuitry 830; at least one bus 890; and additional support circuitry 840. Program storage 870 includes modules that, in an embodiment shown in FIG. 9, provide for detecting a fault in an electrical machine, and that, in an embodiment shown in FIG. 10, provide for classifying a fault in an electrical machine.

FIG. 9 illustrates modules for the embodiment of the system that detects a fault in an electrical machine. Module 910 monitors the analog variables. Module 920 stores the predetermined definitions of input and output membership functions, including the shapes and membership boundaries. Module 920 also stores the rule set. Module 930 receives the values of the input variables being monitored by module 910, and fuzzifies them into truth values for the corresponding input membership functions. Module 940 defines a final antecedent truth value.

As discussed previously, where there is only one membership function in the antecedent, its truth value is considered the final antecedent truth value. When there are a plurality of membership functions in the antecedent, the fuzzy logic operator specified in the rule set is applied to the plurality of associated truth values, with the result yielding the final antecedent truth value. Module 950 implicates the final antecedent truth value for a given rule onto the output membership function for that rule, yielding a fuzzy set. Module 960 aggregates the output fuzzy sets into a combined output fuzzy set. Module 970 defuzzifes the combined output fuzzy set to yield a crisp value.

FIG. 10 illustrates modules for the embodiment of the system that classifies a fault in an electrical machine. Module 1010 monitors the analog variables. Module 1020 stores the predetermined definitions of input and output membership functions, including the shapes and membership boundaries. Module 1020 also stores the rule set. Module 1030 receives the values of the input variables being monitored by module 1010, and fuzzifies them into truth values for the corresponding input membership functions, and or into truth values for the complement of the corresponding input membership functions, where a NOT operator is present. Module 1040 defines a final antecedent truth value. Module 1050 implicates the final antecedent truth value for a given rule onto the output membership function for that rule, yielding a fuzzy set. There is only one fuzzy output set for each analog variable, and thus there is no need for aggregation into a combined output fuzzy set. Module 1060 defuzzifes the output fuzzy set for each analog variable, yielding a crisp value for each.

One of ordinary skill in the art will also comprehend that an embodiment of the method for detecting process flaws using fuzzy logic of the present invention can be provided in the form of a computer program product.

The present invention has been described above with reference to several specific embodiments. It will, however, be evident to those of ordinary skill in the art that various modifications and changes can be made thereto without departing from the invention, the scope of which is to be determined by the claims that follow.

What is claimed is:

1. A fuzzy expert system to detect a fault in an electrical machine, the fuzzy expert system comprising:
a distributed control system (DCS) including: a non-volatile memory device that stores calculation modules and data; a processor coupled to the memory; a human-machine interface;
input and output circuitry; at least one bus; and at least one communications protocol; wherein information from sensors is transmitted to the input circuitry using the at least one communications protocol, with the input circuitry then transmitting the information to the processor over the at least one bus; and wherein the processor transmits instructions to the output circuitry, with the output circuitry then transmitting the instructions to final elements;
a first calculation module that monitors at least two analog variables, comprising lube oil pressure and lube oil temperature, from sensors associated with the electrical machine;
a second calculation module that is preprogrammed with:
at least one input membership function for each of the at least two analog variables, wherein each of the input membership functions includes a shape and at least one membership boundary;
normal, high and high-high output membership functions, representing performance levels for the electrical machine, wherein each of the output membership functions includes a shape and at least one membership boundary; and
a plurality of rules, each rule comprising an antecedent of one or more input membership functions, and further comprising a consequent of one of the output membership functions, wherein in the case of an antecedent of two or more input membership functions, the rule further comprises a fuzzy operator;
a third calculation module that, for each rule, receives from the first calculation module the values of the analog variable or variables that corresponds to the one or more input membership functions in the antecedent, and that fuzzifies each analog value into a truth value for the corresponding input membership function;
a fourth calculation module that defines a final antecedent truth value, wherein:
for each rule with only one membership function defined in the antecedent, the final antecedent truth value is equal to the fuzzified truth value calculated by the third calculation module for the input membership function of that rule, and
for each rule with a plurality of membership functions defined in the antecedent, the predetermined fuzzy operator is applied to the plurality of fuzzified truth values that were calculated by the third calculation module for the input membership functions of that rule, and the result is defined as the final antecedent truth value;
a fifth calculation module that, for each rule, implicates the final antecedent truth value onto the output membership function, using the minimum function, yielding an output fuzzy set;
a sixth calculation module that aggregates the output fuzzy sets from the fifth calculation module into a combined output fuzzy set, using the maximum function; and
a seventh calculation module that applies a predetermined defuzzification method to the combined output fuzzy set, to determine a crisp value representing the health of the electrical machine; and that stores the crisp value in memory and makes it available to an operator via the human-machine interface.

2. The fuzzy expert system of claim 1, wherein each of the at least one input membership function has a shape such that input truth values from zero to one take a linear form.

3. The fuzzy expert system of claim 1, wherein the defuzzification method is center of gravity.

4. The fuzzy expert system of claim 1, wherein the electrical machine is an air compressor.

5. A fuzzy expert system to classify a fault in an electrical machine, the fuzzy expert system comprising:
a distributed control system (DCS) including: a non-volatile memory device that stores calculation modules and data; a processor coupled to the memory; a human-machine interface;
input and output circuitry; at least one bus; and at least one communications protocol; wherein information from sensors is transmitted to the input circuitry using the at least one communications protocol, with the input circuitry then transmitting the information to the processor over the at least one bus; and wherein the processor transmits instructions to the output circuitry, with the output circuitry then transmitting the instructions to final elements;
a first calculation module that monitors at least two analog variables, comprising lube oil pressure and lube oil temperature, from sensors associated with the electrical machine;
a second calculation module that is preprogrammed with:
an input membership function and an output membership function for each of the at least two analog variables, wherein each membership function includes a shape and at least one membership boundary; and
a rule for each of the at least two analog variables, each rule associated with one of the at least two analog variables, wherein each rule comprises an antecedent and a consequent, and wherein the antecedent comprises the input membership function associated with the analog variable of that rule and the complement of the input membership function associated with every other of the at least two analog variables;
a third calculation module that, for each rule, receives from the first calculation module the values of the analog variables and that fuzzifies each analog value into a truth value for the corresponding input membership function or its complement, as specified by the rule;
a fourth calculation module that, for each rule, applies the AND operator using the minimum function to the fuzzified truth values calculated in the third calculation module, yielding a final antecedent truth value;
a fifth calculation module that, for each rule, implicates the final antecedent truth value onto the output membership function, using the minimum function, yielding an output fuzzy set; and
a sixth calculation module that, for each rule, applies a predetermined defuzzification method to the output fuzzy set obtained for that rule, to determine a crisp value representing whether the analog variable associated with that rule represents a fault; and that stores the crisp value in memory and makes it available to an operator via the human-machine interface.

6. The fuzzy expert system of claim 5, wherein each of the at least one input membership function has a shape such that input truth values from zero to one take a linear form.

7. The fuzzy expert system of claim 5, wherein the defuzzification method is center of gravity.

8. The fuzzy expert system of claim 5, wherein the electrical machine is an air compressor.

9. A method of detecting a fault in an electrical machine, comprising:
defining at least one input membership function for each of at least two analog variables from sensors associated with the electrical machine, the sensors comprising lube oil pressure and lube oil temperature, wherein each of the at least one input membership function includes a shape and at least one membership boundary;
defining normal, high and high-high output membership functions for a variable representing a performance level for the electrical machine, wherein each output membership function includes a shape and at least one membership boundary;
defining a rule set that correlates the fuzzy sets of the input membership functions with the fuzzy sets of the normal, high and high-high output membership functions, such that each rule in the rule set has one or more input membership functions and one output membership function;
receiving the values of the at least two analog variables from the sensors, and fuzzifying each value, thereby calculating a truth value for each of the at least one input membership function associated with each analog variable;
determining an antecedent truth value for each rule of the rule set, wherein:
for each rule that has a single input membership function, the antecedent truth value is the calculated truth value of the single input membership function; and
for each rule that has a plurality of input membership functions, the antecedent truth value is derived by applying the fuzzy operator specified in the antecedent of that rule to the calculated truth values for the plurality of input membership functions, wherein the minimum method is used for an AND fuzzy operator and the maximum method is used for an OR fuzzy operator;
implicating the antecedent truth value for each rule onto the output membership function for that rule, using the minimum function, yielding an output fuzzy set for each rule;
amalgamating the output fuzzy set for each rule into a combined output fuzzy set; and
calculating a crisp value by applying a predetermined defuzzification method to the output fuzzy set, wherein the crisp value represents the health of the electrical machine.

10. The method of claim 9, wherein each of the at least one input membership function has a shape such that input truth values from zero to one take a linear form.

11. The method of claim 9, wherein the defuzzification method is center of gravity.

12. The method of claim 9, wherein the electrical machine is an air compressor.

13. A method of classifying a fault in an electrical machine, comprising:
defining an input membership function and an output membership function for each of at least two analog variables from sensors associated with the electrical machine, the sensors comprising lube oil pressure and lube oil temperature, wherein each membership function includes a shape and at least one membership boundary;
defining a rule for each of the at least two analog variables, having an antecedent and a consequent, wherein the antecedent comprises the input membership function associated with the analog variable of that rule, and that further comprises the complement of the input membership functions associated with every other analog variable; and wherein the consequent has a single output membership function;
receiving the values of the at least two analog variables from the sensors, and for each rule, fuzzifying the value for the analog variable associated with that rule into a truth value for its associated input membership function, and fuzzifying the value for every other analog variable into a truth value for the associated complementary input membership function;
determining an antecedent truth value for each rule of the rule set, by applying the AND fuzzy operator using the minimum method to the truth values determined for the input membership function and complementary input membership functions;
implicating the antecedent truth value for each rule onto the output membership function for that rule, using the minimum function, yielding an output fuzzy set for each rule; and
calculating a crisp value for each output fuzzy set, by applying a predetermined defuzzification method, wherein the crisp value represents the health of the analog variable associated with that rule.

14. The method of claim 13, wherein each of the at least one input membership function has a shape such that input truth values from zero to one take a linear form.

15. The method of claim 13, wherein the defuzzification method is center of gravity.

16. The method of claim 13, wherein the electrical machine is an air compressor.

17. A computer program product to detect a fault in an electrical machine, comprising:
a non-transitory computer readable medium having computer readable program code embodied therein that, when executed by a processor of a distributed control system (DCS), causes the processor to:
define at least one input membership function for each of at least two analog variables from sensors associated with the electrical machine, the sensors comprising lube oil pressure and lube oil temperature, wherein each of the at least one input membership function includes a shape and at least one membership boundary;
define normal, high and high-high output membership functions for a variable representing a performance level for the electrical machine, wherein each output membership function includes a shape and at least one membership boundary;
define a rule set that correlates the fuzzy sets of the input membership functions with the fuzzy sets of the normal, high and high-high output membership functions, such that each rule in the rule set has one or more input membership functions and one output membership function;
receive the values of the at least two analog variables from the sensors, and fuzzify each value, thereby calculating a truth value for each of the at least one input membership function associated with each analog variable;
determine an antecedent truth value for each rule of the rule set, wherein:
for each rule that has a single input membership function, the antecedent truth value is the calculated truth value of the single input membership function; and
for each rule that has a plurality of input membership functions, the antecedent truth value is derived by applying the fuzzy operator specified in the antecedent of that rule to the calculated truth values for the plurality of input membership functions, wherein the minimum method is used for an AND fuzzy operator and the maximum method is used for an OR fuzzy operator;
implicate the antecedent truth value for each rule onto the output membership function for that rule, using the minimum function, yielding an output fuzzy set for each rule;
amalgamate the output fuzzy set for each rule into a combined output fuzzy set; and
calculate a crisp value by applying a predetermined defuzzification method to the output fuzzy set, wherein the crisp value represents the health of the electrical machine.

18. The computer program product of claim 17, wherein each of the at least one input membership function has a shape such that input truth values from zero to one take a linear form.

19. The computer program product of claim 17, wherein the defuzzification method is center of gravity.

20. The computer program product of claim 17, wherein the electrical machine is an air compressor.

21. A computer program product to classify a fault in an electrical machine, comprising:
a non-transitory computer readable medium having computer readable program code embodied therein that, when executed by a processor of a distributed control system (DCS), causes the processor to:
define an input membership function and an output membership function for each of at least two analog variables from sensors associated with the electrical machine, the sensors comprising lube oil pressure and lube oil temperature, wherein each membership function includes a shape and at least one membership boundary;
define a rule for each of the at least two analog variables, having an antecedent and a consequent, wherein the antecedent comprises the input membership function associated with the analog variable of that rule, and that further comprises the complement of the input membership functions associated with every other analog variable; and wherein the consequent has a single output membership function;
receive the values of the at least two analog variables from the sensors, and for each rule, fuzzify the value for the analog variable associated with that rule into a truth value for its associated input membership function, and fuzzifying the value for every other analog variable into a truth value for the associated complementary input membership function;
determine an antecedent truth value for each rule of the rule set, by applying the AND fuzzy operator using the minimum method to the truth values determined for the input membership function and complementary input membership functions;
implicate the antecedent truth value for each rule onto the output membership function for that rule, using the minimum function, yielding an output fuzzy set for each rule; and
calculate a crisp value for each output fuzzy set, by applying a predetermined defuzzification method, wherein the crisp value represents the health of the analog variable associated with that rule.

22. The computer program product of claim 21, wherein each of the at least one input membership function has a shape such that input truth values from zero to one take a linear form.

23. The computer program product of claim 21, wherein the defuzzification method is center of gravity.

24. The computer program product of claim 21, wherein the electrical machine is an air compressor.
